(19) United States
(12) Patent Application Publication
(10) Pub. No.: US 2015/0213308 A1
(43) Pub. Date: Jul. 30, 2015

(54) METHOD AND SYSTEM FOR ANALYZING HUMAN BEHAVIOR IN AN INTELLIGENT SURVEILLANCE SYSTEM

(71) Applicant: POLITECHNIKA POZNANSKA, Poznan (PL)

(72) Inventors: Slawomir MACKOWIAK, Poznan (PL); Lukasz KAMINSKI, Koszalin (PL); Krzysztof KOWALAK, Poznan (PL); Pawel GARDZINSKI, Plock (PL); Lukasz JANUSZKIEWICZ, Jastrowie (PL)

(73) Assignee: POLITECHNIKA POZNANSKA, Poznan (PL)

(21) Appl. No.: 14/215,101

(22) Filed: Mar. 17, 2014

(30) Foreign Application Priority Data
Jan. 28, 2014 (PL) PL406971

(51) Int. Cl. G06K 9/00; G06T 7/20

(52) U.S. Cl. CPC G06K 9/00335; G06T 7/2033; G06T 2207/10016; G06T 2207/30232; G06T 2207/30241

(57) ABSTRACT

A method for analyzing behavior in an intelligent surveillance system, the system being operable to provide a series of consecutive images of an area under surveillance for consecutive time points, the method comprising the steps of: for each image of the series, generating a set of points defining at least one moving silhouette on an image; tracing the position of points in the sets of points on consecutive images in order to generate trajectories of points; providing a database of predefined trajectories corresponding to behavior; comparing the generated trajectories of points for said moving silhouette with database records; outputting information regarding the type of predefined behavior said moving silhouette corresponds to.

### TECHNICAL FIELD

The foregoing description relates to analysis of human behavior, involving description and identification of actions, in order to automatically recognize behavior type in an intelligent surveillance system.

### BACKGROUND

There are known a number of approaches to automated behavior analysis systems.

A U.S. Pat. No. 8,131,012 presents a method and a system for analyzing and learning behavior based on an acquired stream of video frames. Objects depicted in the stream are determined based on an analysis of the video frames. Each object may have a corresponding search model used to track an object's motion frame-to-frame. Classes of the objects are determined and semantic representations of the objects are generated.

A US patent application US200310107650 discloses a surveillance and security system for automatic detection and warning of detected events, which includes a unit for observing behavior in a predetermined area under surveillance, a unit for processing an output of observed behavior from the unit for observing, and a pattern recognition module for recognizing whether the observed behavior is associated with predefined suspicious behaviors. The pattern recognition module may include infrared heat profiles of persons, images of actual people, sequences of people manipulating shopping bags, sounds of tearing of different types of packaging. The observation of motion, which is related to behavior, is compared against a database of predefined acts.

A U.S. Pat. No. 5,666,157 presents a surveillance system having at least one primary video camera for translating real images of a zone into electronic video signals at a first level of resolution. The system includes means for sampling movements of an individual or individuals located within the zone from the video signal output from at least one video camera. Video signal of sampled movements of the individual is electronically compared with known characteristics of movements which are indicative of individuals having a criminal intent.

It is the aim to provide further improvements to analyzing human behavior in an intelligent surveillance system.

### SUMMARY

There is presented a method for analyzing behavior in an intelligent surveillance system, the system being operable to provide a series of consecutive images of an area under surveillance for consecutive time points, the method comprising the steps of: for each image of the series, generating a set of points defining at least one moving silhouette on an image; tracing the position of points in the sets of points on consecutive images in order to generate trajectories of points; providing a database of predefined trajectories corresponding to behavior; comparing the generated trajectories of points for said moving silhouette with database records; outputting information regarding the type of predefined behavior said moving silhouette corresponds to.

Preferably, to detect at least one type of behavior, a set of points is generated having a configuration different than a set of points for another type of behavior.

Preferably, said step of generating a set of points defining at least one moving silhouette on an image comprises generating negative curvature minima.

Preferably, said step of generating a set of points defining at least one moving silhouette on an image comprises generating positive curvature maxima.

Preferably, said step of generating a set of points defining at least one moving silhouette on an image comprises generating negative curvature minima and positive curvature maxima.

There is also presented a computer program comprising program code means for performing all the steps of the computer-implemented method as described here when said program is run on a computer, as well as to a computer readable medium storing computer-executable instructions performing all the steps of the computer-implemented method as described here when executed on a computer.

There is also presented a system for analyzing behavior in an intelligent surveillance system, the system comprising an image sequence input module configured to provide a series of consecutive images of an area under surveillance for consecutive time points, the system further comprising: a silhouette detector configured to generate, for each image of the series, a set of points defining at least one moving silhouette on an image; a trajectories generator configured to trace the position of points in the sets of points on consecutive images in order to generate trajectories of points; a reference database configured to store predefined trajectories corresponding to behavior; a comparator and behavior detector configured to compare the generated trajectories of points for said moving silhouette with the reference database records; an output module configured to output information regarding the type of predefined behavior said moving silhouette corresponds to.

Any combinations of the features described above are envisaged.

The presented method is particularly useful for automatic recognition of human behavior and can be used in intelligent surveillance systems, including systems having a single stationary camera.

### BRIEF INTRODUCTION TO THE DRAWINGS

The method and system are presented by means of example embodiments on a drawing, in which:

FIG. 1 illustrates characteristic points, a pose, a trajectory and a descriptor;

FIG. 2 illustrates an exemplary image of a person with a set of characteristic points;

FIG. 3 shows an example of an NCM point;

FIG. 4 presents a third points selection method;

FIG. 5 presents a fourth points selection method;

FIG. 6 shows an exemplary outline for defining PCM points;

FIG. 7 presents exemplary trajectories of moving objects; and

FIG. 8 presents a top level method.

FIG. 9 presents a system for analyzing human behavior.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities.

Usually these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or similar.

Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or similar, refer to the action and processes of a computer system that manipulates and transforms data represented as physical (electronic) quantities within the computer's registers and memories into other data similarly represented as physical quantities within the memories or registers or other such information storage.

### DETAILED DESCRIPTION

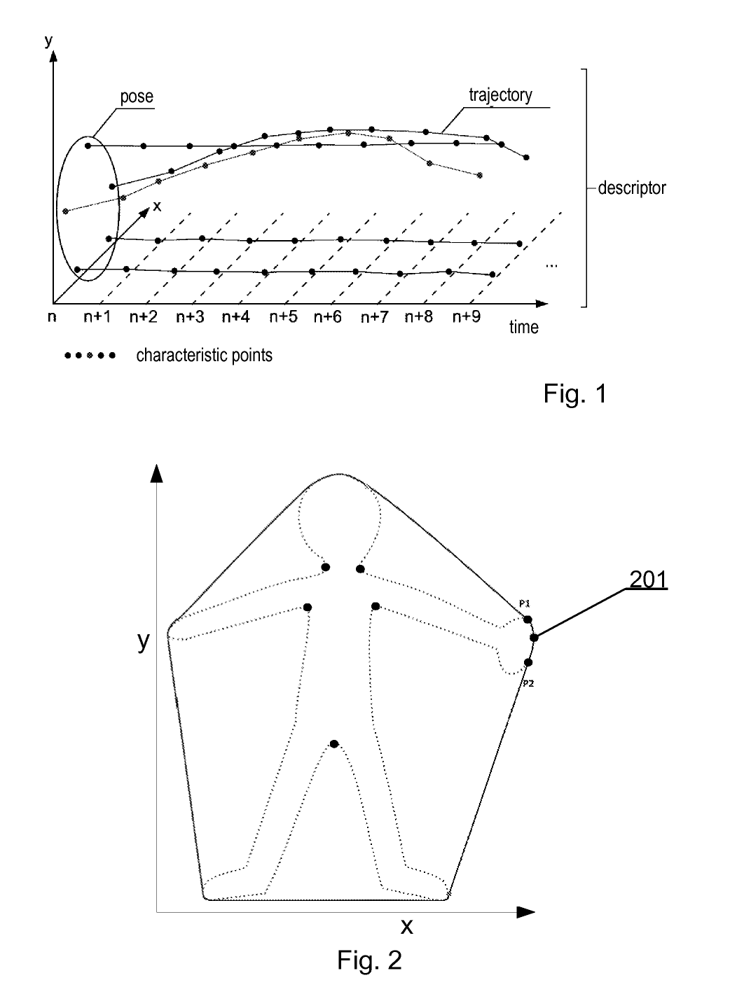

The behavior of a person can be described by a set of trajectories of characteristic points of the person, as shown in FIG. 1. A set of characteristic points at a given time defines a pose. A set of poses defined for consecutive time points or a set of time vectors for individual points forms a descriptor.

The set of points to define a pose may have a different configuration for different types of behavior to be detected. In other words, for at least one type of behavior, a set of points is generated having a configuration different than a set of points for another type of behavior. For example:
In order to detect low complexity behaviors, such as simple arm wave gestures, the person may be characterized by three points, i.e. one point located at the head and two points located at the feet or one point located at the head and two points located at the palms,
In order to detect medium complexity behaviors, such as calling for help, the person may be characterized by five points, i.e. one point located at the head, two points located at the feet and two points located at the palms, as shown in the example of FIG. 1,
In order to detect high complexity behaviors, such as dancing or more complex motions, where elbows and knees make significant maneuvers, the person may be characterized by seven points, i.e. one point located at the head, two points located at the feet, two points located at the palms, and two points located at the elbows.

It shall be noted that the sets of points defined above are an example only and are non-limiting. Other pose-defining points and/or their combinations or numbers are possible without departing from the presented idea.

For consecutive frames, the positions of points belonging to the set are traced to form trajectories of points.

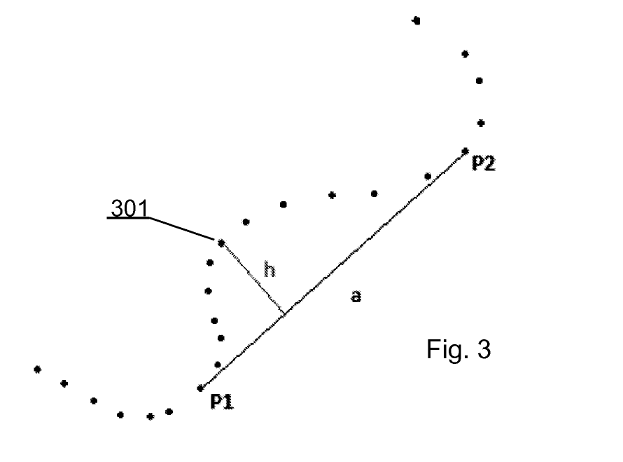

There are different ways of describing shapes in images. The presented system is based on the contours of objects in the scene, which are well characterized using the so-called concavity minima or negative curvature minima (NCM) points. These points may be used, inter alia, to recognize persons in video sequences, as described in article “Dressed Human Modeling, Detection and Parts Localization” by Zhao, L., Carnegie Mellon University Pittsburg (2001). The definition of minimum concavity is as follows: an NCM point is a point of the contour between the points (P1, P2 in FIG. 3) of a convex contour, for which the distance from the segment ∥P1 P2∥ is largest. The points P1 and P2 are suitably distant from each other which will be described in details in the subsequent sections of the present description. FIG. 3 shows an example of an NCM point 301.

Like the concavity minima, contour convexity may be used to describe the curvature. The method utilizing contour convexity is called positive curvature maxima (PCM) points. This time, the extreme points P1 and P2 in FIG. 3 are selected from the convex contour so that P1 is the point closing the i-th concavity and P2 is a point opening the i+1-th concavity. FIG. 2 shows an example of a PCM point 201. Among so selected pair of points, from the contour a PCM point is selected so that the distance from the segment |P1P2| is as high as possible.

There are possible different methods for determining the characteristic points.

The first method, according to one example embodiment of the presented system, is called “Midpoint and four extreme points”. This is well suited for detecting behavior, in which human limbs are widely positioned, for example, while waving person's arms or crying for help.

The method sets four points {A, B, C, D}, wherein the Euclidean distance from the geometric center of the contour P is the greatest. These points are computed, one in each quadrant of the coordinate system having a center located at point P, by the formula:

$${A}_{x} = \frac{{p}_{x}^{i} - {P}_{x}}{w}$$

$${A}_{y} = \frac{{p}_{y}^{i} - {P}_{y}}{h}$$

Wherein the following references refer to:
Aₓ,A_{y}—coordinates x and y of the calculated point,
w—contour's width on 0X axis,
h—contour's height on 0Y axis,
Pₓ,P_{y}—coordinates x and y of the contour's central point,
Pₓⁱ,P_{y}ⁱ—coordinates x and y of the i-th contour's point.

Another example method, also utilizing the concept of the “Midpoint and four extreme points”, applies a different normalization process. The method differs from the previous one in that it applies normalization of x coordinates, calculated according to the formula:

$${A}_{x} = \frac{{p}_{x}^{i} - {P}_{x}}{h}$$

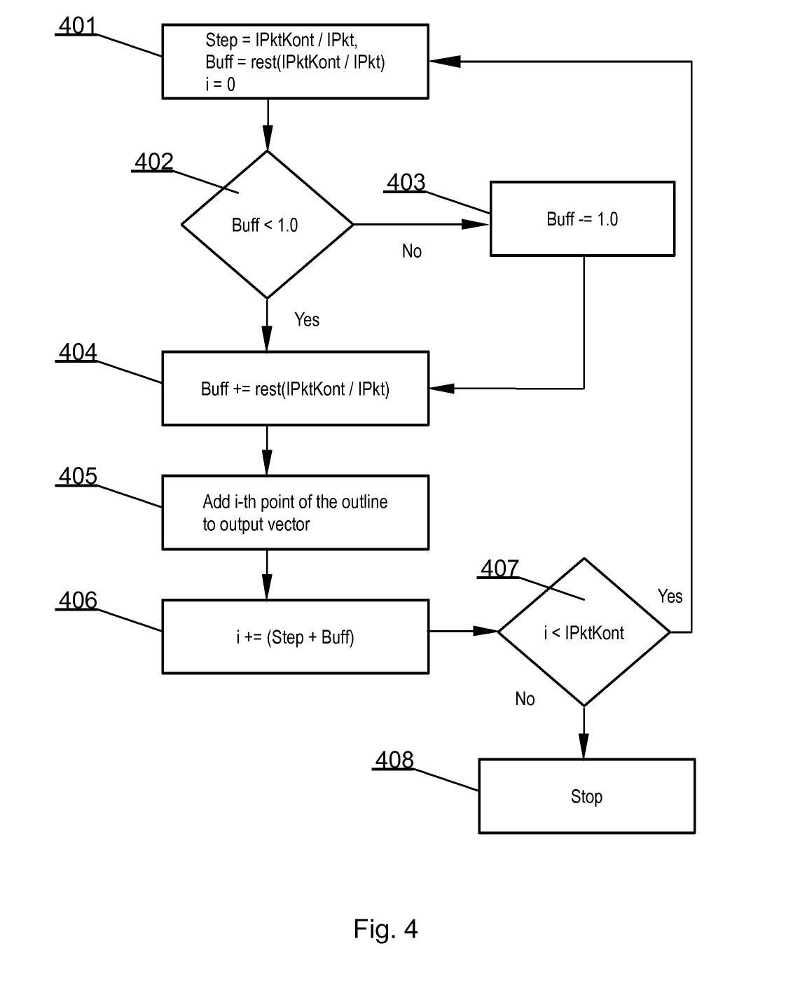

A third method is called “Points evenly spread on the contour”. The method of points selection is based on selection of evenly spread, arbitrary number of points from the contour typically of a silhouette). Such approach allows for gradual selection of the level of contour mapping. The method has been depicted in FIG. 4, wherein the following references refer to:
Step—step of selection of consecutive points;
Buff—a buffer storing reminder of a division in order to minimize an error caused by calculations on integer numbers. It is a case when the Step is not an integer;
rest(IPktKont/IPkt)—a function calculating a reminder of a division.

The selected contour points define a descriptor of the contour (typically of a silhouette of a person) in a given video frame and are buffered in an output vector as shown in FIG. 4.

More specifically, the procedure in FIG. 4 starts from step 401, where the Step variable is set a value of IPktKont/IPkt, wherein IPkt denotes chosen number of equally distant points on object contour and IPktKont denotes a total number of points in object contour, the Buff variable is set to rest(IPktKont/IPkt) and the ‘i’ variable is set to 0. Next, at step 402, it is verified whether the value of the Buff variable is less than 1. In case it is not, at step 403 the value of Buff variable is decreased by 1.0 before moving to step 404. Otherwise, at step 404, the value of the Buff variable is increased by the rest of the quotient (IPktKont/IPkt). Subsequently, at step 405, the i-th point of the contour is added to an output vector as a selected point. Next, at step 406, the variable ‘i’ is set to a value of Step+Buff. At step 407 it is verified whether ‘i’ is lower that IPktKont and in case it is the process returns to step 401 in order to process the next point or otherwise the procedure ends at step 408.

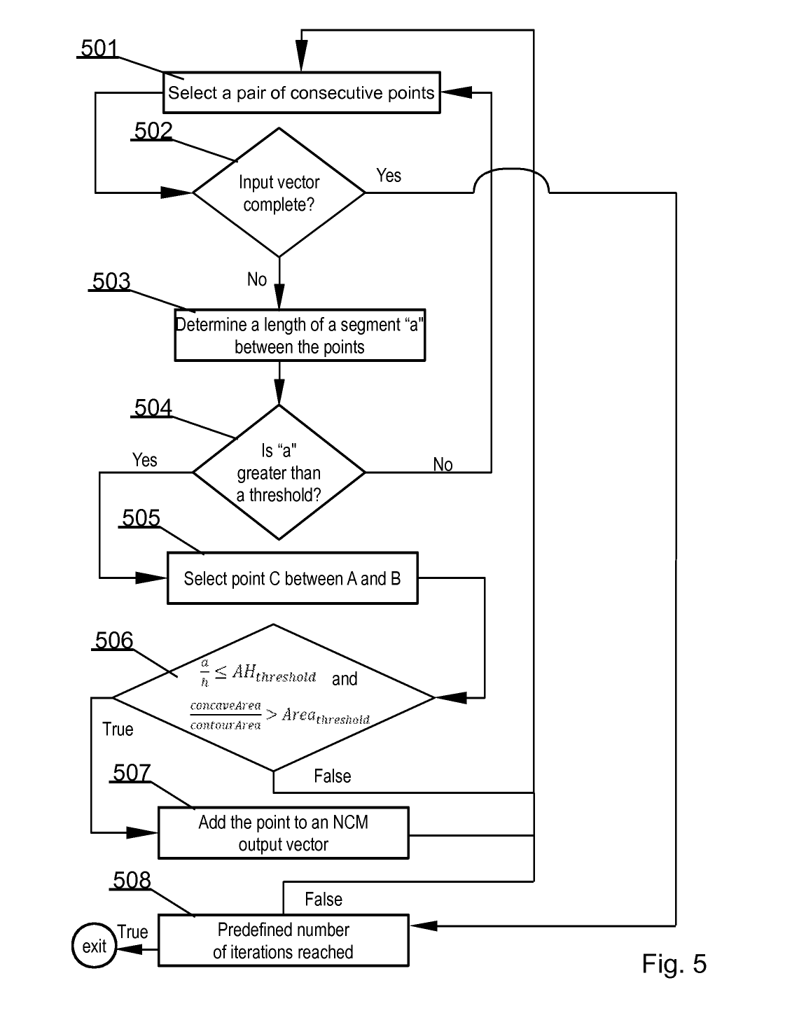

The fourth example method is based on NCM points and PCM points and has been depicted in FIG. 5. Because of such combination it is possible to describe silhouettes with data defining curvature of the contour—NCM for negative curvature minima and PCM for positive curvature maxima.

A procedure for determining NCM points starts from step 501 with selecting a pair of consecutive points {A, B} in a vector of a convex contour. If a complete vector of the convex contour has been analyzed, the procedure proceeds from step 502 to step 508. If not, then in step 503 there is determined a length of a segment “a” between the points {A, B}. Next, at step 504, it is verified whether the length “a” is greater than a threshold. In case the length “a” is greater than the threshold, the procedure proceeds to step 505. Otherwise the procedure returns to step 501 in order to select another pair of points. At step 505, there is selected a point C from the convex contour vector such that point C is between points A and B and such that its distance h from the segment “a” is the greatest.

At step 506 it is verified whether an update contour condition is fulfilled, so that point C may be added to the convex contour. The parameters of the condition are as follows: AH_{threshold} is a concavity depth threshold, concaveArea is an area of concavity defined by the section of the contour between A and B points, contourArea is an inner area of the currently analyzed contour and the Area_{threshold} is a threshold defining minimum ratio of concavity area to the inner area of the currently analyzed contour.

If the condition is fulfilled the procedure moves to step 507 where point C is added to the NCM output vector and the process returns to step 501.

In case, at step 508, the number of iterations has not reached a required count, the process returns to step 501 and selects another pair of points from the vector of convex contour. The process is repeated from the beginning.

The aforementioned update contour method utilizes a known algorithm, such as “Gift wrapping” or “Jarvis march”. Its task is to include in the convex contour a previously selected NCM point so that its definition is maintained. During execution of this method there is added a minimum number of contour points to the contour such that the contour vector maintains its continuity.

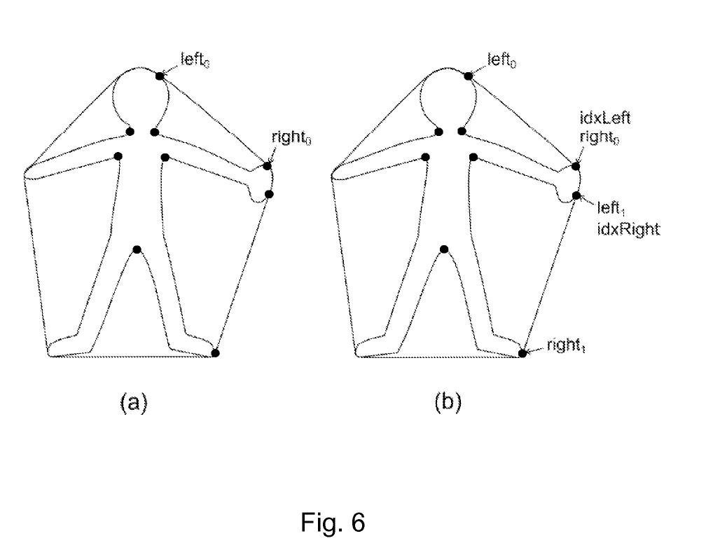

The other part of the fourth method relates to the PCM points that are determined similarly to the NCM points. The method may also be applied to pairs of points of a convex contour and is executed as follows. First there are selected pairs of points {leftᵢ, rightᵢ} until a pair fulfilling the condition of step 504 is obtained, thereby obtaining {leftᵢ, rightᵢ} pair shown in FIG. 6 as element (a). There is also stored an index of a point right₀ in the contour vector as idxLeft.

The second step is to move the {leftᵢ, rightᵢ} until a next pair is found that fulfils the NCM condition thereby arriving at {left₁, right₁} shown in FIG. 6 variant (b). The index of left₁ in the contour vector is stored as idxRight.

The third step of the procedure is to select a point K₀ from the convex contour between idxLeft and idxRight, for which the distance h₀ from the segment |right₀left₁| is the greatest.

Lastly, as the fourth step set the idxLeft=idx(right1) and continue from the second step.

The subsequent K points are computed in an analogous way by maximizing their corresponding distances hᵢ from the segments |rightᵢleftᵢ₊₁|. The process executes its last iteration when leftₙ=left₀. The vector of calculated points is added to previously determined NCM points thereby creating a pose descriptor.

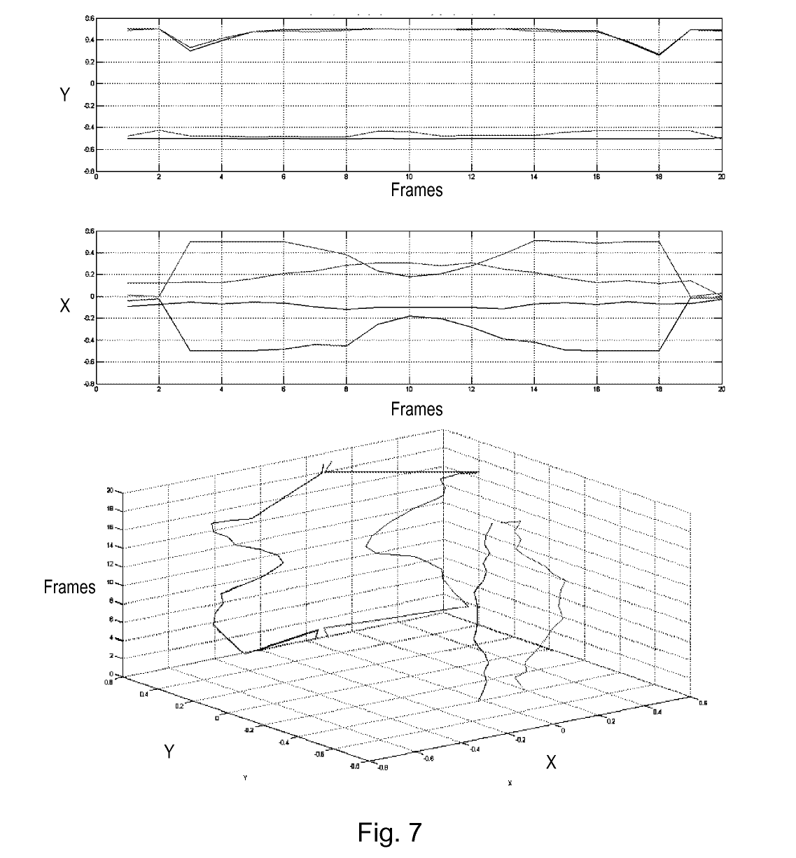

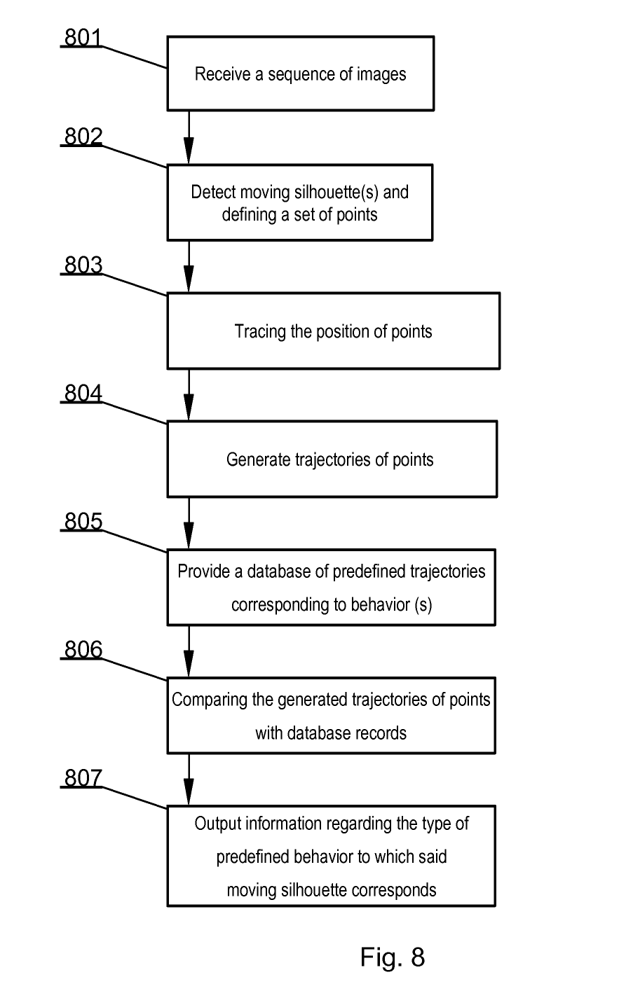

FIG. 8 presents in general the method for analyzing human behavior. The method is utilized for analyzing behavior in an intelligent surveillance system, the system being operable to provide a series of consecutive images 801 of an area under surveillance for consecutive time points. At step 802, for each image of the series, there is generated a set of points defining at least one moving silhouette on an image. Subsequently, at step 803, position of points in the sets of points on consecutive images are traced in order to generate trajectories of points at step 804. Exemplary trajectories are shown in FIG. 7, wherein the first chart from the top presents positions of points on consecutive frames in Y axis and the second chart presents positions of points on consecutive frames in X axis. The bottom chart represents trajectories on both axes, wherein the horizontal axes represent position of points on X, Y axis and the vertical axis represents consecutive frames. Each line corresponds to a trajectory of a different point. Next, at step 805, there is provided a database of predefined trajectories corresponding to the behavior, so that at step 806 the generated trajectories of points for said moving silhouette can be compared with reference database records. The comparison is performed by analyzing the trajectory related to a certain number of previous frames, wherein the number of frames depends on the reference trajectory for a particular type of activity, with which the observer trajectory is compared.

The comparison is performed by calculating the Euclidean distance for pairs of corresponding points. Each trajectory shall fit within a predetermined range. For example, assuming that 4 points of a person are traced (e.g. two palms and two feet), the characteristic point designated as the right palm must, for each frame, be located in a distance D not larger than from the reference “right hand” for each behavior, namely:

D=\sqrt{(x_{ab}−x_{wz})²+(y_{ab}−y_{wz})²}

### D≦B

wherein x_{ab}, y_{ab} designate the position of characteristic points (caution: these are not spatial coordinates) and x_{wz}, y_{wz} designate corresponding reference values.

Finally, at step 807, there is output information regarding the type of predefined behavior to which said moving silhouette corresponds. Such information may be used in order to provide suitable alerts.

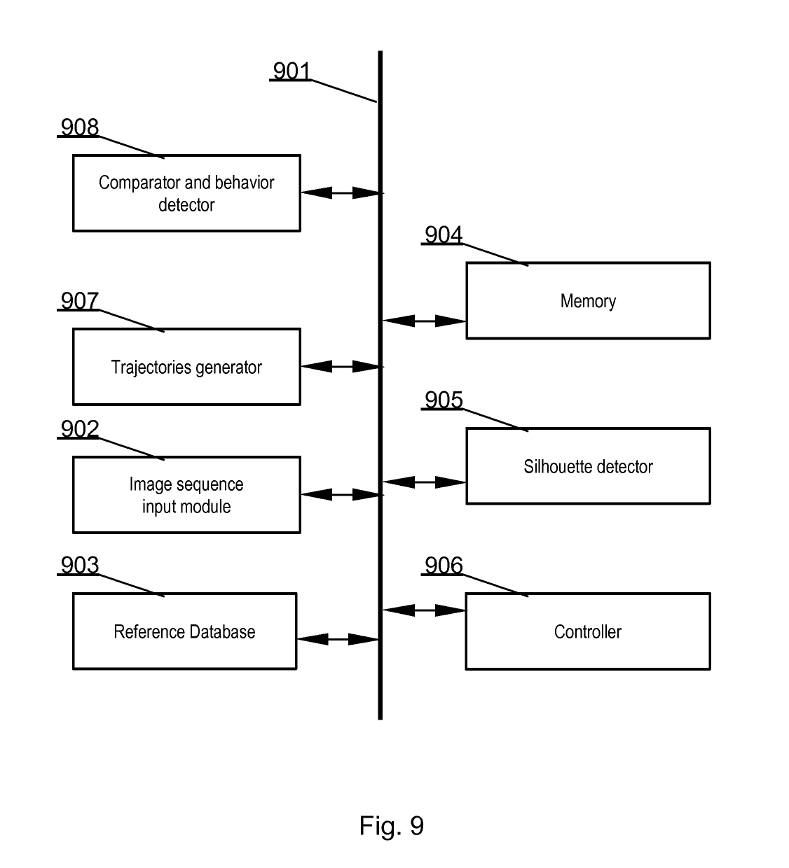

FIG. 9 presents a system for analyzing human behavior. The system may be realized using dedicated components or custom made FPGA or ASIC circuits. The system comprises a data bus 901 communicatively coupled to a memory 904. Additionally, other components of the system are communicatively coupled to the system bus 901 so that they may be managed by a controller 906. An image sequence input module 902 is responsible for providing images data. The images are stored in the memory 904 until a sufficiently long sequence of images may be notified to the controller 906, which shall execute a process of detecting moving objects and silhouette(s) 902 by a specified silhouette detector module 905.

Furthermore, the system comprises a trajectories generator 907 that based on output from the silhouette detector module 905 defines trajectories of points. The system also comprises a reference database 903 for storing previously defined behavior trajectories. Based on data from the trajectories generator 907 and the reference database 903, the comparator and behavior detector module detects whether the presently analyzed behavior matches at least one of known behaviors. This information may be output externally by an output module.

It can be easily recognized, by one skilled in the art, that the aforementioned method for analyzing human behavior in an intelligent surveillance system may be performed and/or controlled by one or more computer programs. Such computer programs are typically executed by utilizing the computing resources in a computing device such as personal computers, personal digital assistants, cellular telephones, receivers and decoders of digital television or similar. Applications are stored on a non-transitory medium. An example of a non-transitory medium is a non-volatile memory, for example a flash memory or volatile memory, for example RAM. The computer instructions are executed by a processor. These memories are exemplary recording media for storing computer programs comprising computer-executable instructions performing all the steps of the computer-implemented method according the technical concept presented herein.

While the features presented herein has been depicted, described, and has been defined with reference to particular preferred embodiments, such references and examples of implementation in the foregoing specification do not imply any limitation on the features. It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification, but is only limited by the claims that follow.

We claim:

1. A method for analyzing behavior in an intelligent surveillance system, the system being operable to provide a series of consecutive images of an area under surveillance for consecutive time points, the method comprising the steps of:
for each image of the series, generating a set of points defining at least one moving silhouette on an image;
tracing the position of points in the sets of points on consecutive images in order to generate trajectories of points;
providing a database of predefined trajectories corresponding to behavior;
comparing the generated trajectories of points for said moving silhouette with database records; and
outputting information regarding the type of predefined behavior said moving silhouette corresponds to.

2. The method according to claim 1, wherein to detect at least one type of behavior, a set of points is generated having a configuration different than a set of points for another type of behavior.

3. The method according to claim 1, wherein said step of generating a set of points defining at least one moving silhouette on an image comprises generating negative curvature minima.

4. The method according to claim 1, wherein said step of generating a set of points defining at least one moving silhouette on an image comprises generating positive curvature maxima.

5. The method according to claim 1, wherein said step of generating a set of points defining at least one moving silhouette on an image comprises generating negative curvature minima and positive curvature maxima.

6. A computer program comprising program code means for performing all the steps of the computer-implemented method according to claim 1 when said program is run on a computer.

7. A computer readable medium storing computer-executable instructions performing all the steps of the computer-implemented method according to claim 1 when executed on a computer.

8. A system for analyzing behavior in an intelligent surveillance system, the system comprising an image sequence input module configured to provide a series of consecutive images of an area under surveillance for consecutive time points, the system further comprising:
a silhouette detector configured to generate, for each image of the series, a set of points defining at least one moving silhouette on an image;
a trajectories generator configured to trace the position of points in the sets of points on consecutive images in order to generate trajectories of points;
a reference database configured to store predefined trajectories corresponding to behavior;
a comparator and behavior detector configured to compare the generated trajectories of points for said moving silhouette with the reference database records; and
an output module configured to output information regarding the type of predefined behavior said moving silhouette corresponds to.
